(19) United States
(12) Patent Application Publication
(10) Pub. No.: US 2015/0135265 A1
(43) Pub. Date: May 14, 2015

(54) AUTOMATIC NETWORK FIREWALL POLICY DETERMINATION

(71) Applicant: MyDigitalShield, Inc., Wilmington, DE (US)

(72) Inventor: Andrew Bagrin, Wilmington, DE (US)

(21) Appl. No.: 14/535,134

(22) Filed: Nov. 6, 2014

Related U.S. Application Data
(60) Provisional application No. 61/902,587, filed on Nov. 11, 2013.

(51) Int. Cl. H04L 29/06; G06Q 10/10

(52) U.S. Cl. CPC H04L 63/02; H04L 63/029; H04L 63/20; G06Q 10/10
USPC 726/1

(57) ABSTRACT

Methods, systems, and apparatus, including computer programs encoded on a computer storage medium, for identifying a first business tool and a second business tool, accessing security policy templates for the first and second business tools, compiling a security policy script by combining the security policy templates including identifying and resolving conflicting security policies, and monitoring network traffic of the first and second business tools based on the security policy script.

### RELATED APPLICATION

This application claims the benefit of U.S. provisional patent application No. 61/902,587, titled Network Security Configuration Wizard for Business, filed 11 Nov. 2013, which is incorporated herein by reference.

### BACKGROUND

This specification relates to network security and, more particularly, automatically determining network firewall policies.

A firewall is a network security system that monitors and controls incoming and outgoing traffic of a computer network. A firewall can block unwanted access (e.g., unauthorized or malicious access) to a computer network based on a set of security policies. For instance, a security policy may allow web browsing traffic only associated with certain standard ports for web browsing. Based on the security policy, a firewall can inspect incoming data packets and discard packets that are associated with non-standard ports for web browsing.

### SUMMARY

In general, one aspect of the subject matter described in this specification can be embodied in methods that include the actions of identifying a first business tool and a second business tool; accessing security policy templates for the first and second business tools; compiling a security policy script by combining the security policy templates wherein compiling the security templates comprises identifying and resolving conflicting security policies; and monitoring network traffic of the first and second business tools based on the security policy script. The action of identifying, accessing, compiling, and monitoring can be performed by one or more computer processors. Other embodiments of this aspect include corresponding systems, apparatus, and computer programs.

These and other aspects can optionally include one or more of the following features. Monitoring network traffic can comprise applying the security policy script to a network security system, causing the network security system to monitor network traffic of the first and second business tools based on the security policy script. Identifying a particular business tool can comprise inspecting network traffic of a previously unknown software, and determining whether the network traffic of the previously unknown software has characteristics matching a network traffic signature of the particular business tool. Resolving conflicting security policies can comprise adding, removing, or updating one or more of the identified conflicting security policies. The aspect can further comprise heuristically updating the security policy script including inspecting network traffic of the first and second business tools for respective network traffic characteristics, and updating the security policy script by adding, removing, or updating one or more particular security policies from the security policy script based on the respective network traffic characteristics. The aspect can further comprise updating at least one of the security policy templates based on at least one of the identified conflicting security policies. A particular business tool can be a payment processing system, point of sale system, phone system, or online reservation system. Identifying a particular business tool can comprise receiving an identifier of the particular business tool from a graphical user interface of a remote computer system.

Another aspect of the subject matter described in this specification can be embodied in systems comprising one or more computer processors programed to perform operations comprising: receiving user selection of a business category in a first interface of a first computer system; and receiving user selection of one or more business tools in a second interface of the first computer system and, based thereon: accessing a data store for security policy templates for the selected business tools; compiling a security policy script by combining the security policy templates wherein compiling the security templates comprises identifying and resolving conflicting security policies; and applying the security policy script to a network security system, causing the network security system to monitor network traffic of the selected business tools to or from the first computer system based on the security policy script. Other embodiments of this aspect include corresponding methods, apparatus, and computer programs.

These and other aspects can optionally include one or more of the following features. A particular selected business tool can be a payment processing system, point of sale system, phone system, or online reservation system for the selected business category. The one or more computer processors can be programed to perform further operations comprising receiving user selection of a restriction level for network traffic in a third interface of the first computer and, based thereon, compiling the security policy script further based on the restriction level. The network traffic of the selected business tools to or from the first computer system can be based, at least, on a network tunneling protocol.

Particular implementations of the subject matter described in this specification can be implemented to realize one or more of the following advantages. The system described herein identifies a first business tool and a second business tool, and accesses security templates for the first and second business tools. The system compiles a security policy script by combining the security policy templates including identifying and resolving conflicting security policies. The system monitors network traffic of the first and second business tools by applying the security policy script to a network firewall, causing the network firewall to monitor network traffic of the first and second business tools based on the security policy script.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for automatic network firewall policy determination.

FIG. 2 illustrates an example user interface for selecting a business category.

FIG. 3 illustrates an example user interface for selecting business tools for a selected business category.

FIG. 4 illustrates another example user interface for selecting business tools for a selected business category.

FIG. 5 illustrates an example user interface for selecting a restriction level for network traffic.

FIG. 6 is a data flow diagram of an example method for automatic network firewall policy determination.

FIG. 7 is a flow chart of another example method for automatic network firewall policy determination

Like reference numbers and designations in the various drawings indicate like elements.

### DETAILED DESCRIPTION

Ordinarily, security policy for a firewall can be configured through a user interface or a text file in which a person (e.g., a system administrator) can set various rules and lists. For instance, rules and lists of a firewall can include access lists allowing or denying access from certain source Internet Protocol (IP) addresses and port numbers, and inspection rules for inspecting traffic based on Transmission Control Protocol (TCP), User Datagram Protocol (UDP), or other specific application protocols (e.g., File Transfer Protocol, Hypertext Transfer Protocol, Simple Mail Transfer Protocol). Configuring rules and access lists of a firewall can be a difficult, if not impossible, task for a person without in-depth technical knowledge of computer network security. It is desirable to provide a person ways to configure a firewall that does not require in-depth technical knowledge of the firewall and computer network security. Particular implementations of the subject matter described in this specification describe methods for automatically determining and configuring the network security policies of a firewall for a computer network. The methods automatically determine the firewall security policies based on user selection of business tools used in the computer network or based on automatic detection of business tools network traffic.

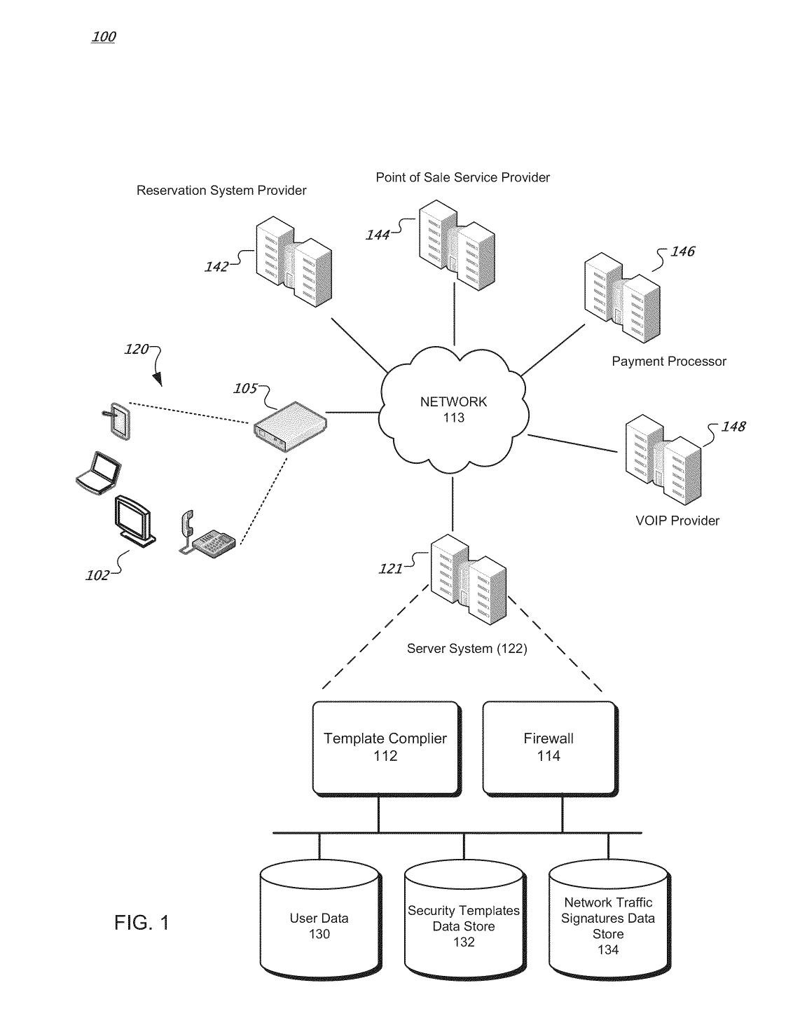

FIG. 1 illustrates an example system for automatic network firewall policy determination. A server system 122 provides functionality of a firewall for a computer network 120 and automatic network security policy determination for the firewall.

The computer network 120 can be a wired or wireless local area network (LAN) for a business, for example. The business can be a retail store (e.g., sporting goods store, hardware store), service provider (e.g., restaurant, coffee shop, cinema, golf course), office (e.g., a realtor, an architecture firm), or health care provider (e.g., a clinic, an outpatient surgery center). Other categories and types of business are possible.

By way of illustration, the computer network 120 includes a plurality of connected devices 102 such as desktop computers, laptop computers, tablet computers, voice over Internet Protocol (VOIP) phones, point of sale (POS) systems, and printers. Other connected devices in the computer network 120 are possible. The computer network 120 connects to one or more data communication networks 113 such as the Internet, for example, through a gateway or router 105.

Multiple business tools can run on the connected devices 102 in the computer network 120. Business tools are software and systems for operating a business such as selling and marketing to consumers, communication with customers and other businesses, and communication among co-workers of the business. Examples of business tools include point of sale system (e.g., Amigo Point of Sale, NCR), payment processing system (e.g., by a bank such as JPMorgan Chase & Co., or a credit card transaction processor such as First Data), phone or VOIP system (e.g., RingCentral), online reservation or ticketing system (e.g., OpenTable, Fandango), online storefront and ordering software (e.g., Shopify), online sales and marketing software (e.g., salesforce.com, sugarCRM), and web hosting system (e.g., web.com, GoDaddy). Other business tools are possible. Data processing and storage of a business tool can be carried out by remote servers of a service provider of the business tool. For instance, telephone switching and storage of call logs for VOIP phones in the computer network 120 can be carried out by remote servers of a VOIP service provider such as RingCentral. Business tools in the computer network 120 can communicate to remote servers of business tool service providers through the network 113.

The server system 122 comprises software components and databases that can be deployed at one or more data centers 121 in one or more geographic locations, for example. The server system 122 software components comprise a template compiler 112 and firewall 114. The software components can comprise subcomponents that can execute on the same or on different individual data processing apparatus. The server system 122 databases comprise a user data database 130, security templates data store database 132, and network traffic signature data store database 134. The databases can reside in one or more physical storage systems. The software components and data will be further described below.

The firewall 114 is a software component that provides firewall functionality for the computer network 120. That is, instead of using the gateway 105 (or a dedicated software or system within the computer network 120) to provide firewall functionality for the computer network 120, all network traffic to and from the computer network 120 can be first routed to the server system 122 and inspected by the firewall 114. For instance, data communication between a point of sale system in the computer network 120 and servers of a point of sale service provider 144 is first routed (via the network 113) to the server system 122 and inspected by the firewall 114. Data communication between an online reservation system in the computer network 120 and servers of a reservation system provider 142 is first routed to the server system 122 and inspected by the firewall 114. Data communication between a payment process system in the computer network 120 and servers of a payment processor 146 is first routed to the server system 122 and inspected by the firewall 114. Data communication between a VOIP phone in the computer network 120 and servers of a VOIP provider 148 is first routed to the server system 122 and inspected by the firewall 114.

In some implementations, the network traffic between the computer network 120 and the server system 122 can uses dedicated network tunnels, for example, using a tunneling protocol such as Generic Routing Encapsulation (GRE) or Layer 2 Tunneling Protocol (L2TP). In yet some implementations, the network traffic between the computer network 120 and the server system 122 can be encrypted, for example, using Transport Layer Security or TLS protocol.

A network traffic signature is a network traffic pattern that corresponds to a particular software or business tool. A network traffic pattern can include values (e.g., address, port number, flag in a header) in data packets based on IP, TCP, UDP, or other network or application protocols. The firewall 114 can inspect network traffic to and from the computer network 120 (or another computer network) and determine network traffic signatures of software and business tools running the computer network 120. Network traffic signatures obtained by the firewall 114 or from another source (e.g., provided by a vendor of a firewall system) can be stored in the network traffic signatures data store database 134. Network traffic signatures stored in the network traffic signatures data store database 134 can be used to identify previously unknown software traffic.

The firewall 114 can provide firewall functionality such as data packet filtering, for example. The firewall 144 can provide additional functionalities such as intrusion detection (e.g., detecting malicious attacks from outside and within the computer network 120 based on network traffic patterns), detection and prevention of denial of service attacks, virtual private network (VPN), and blocking malware, virus, and malicious content. Other network security functionalities provided by the firewall 114 are possible.

To configure network security policy of the firewall 114, a user of the computer network 120 such as the business's owner (who is unlikely a “techie”) does not edit detailed rules and lists as described earlier. Instead, the user can configure the network security policy of the firewall 114 (thus the network security policy of the computer network 120) by selecting, in a user interface, business tools used in the computer network 120. The template compiler 112 of the server system 122 then can automatically determine the network security policy of the firewall 114 based on selected business tools.

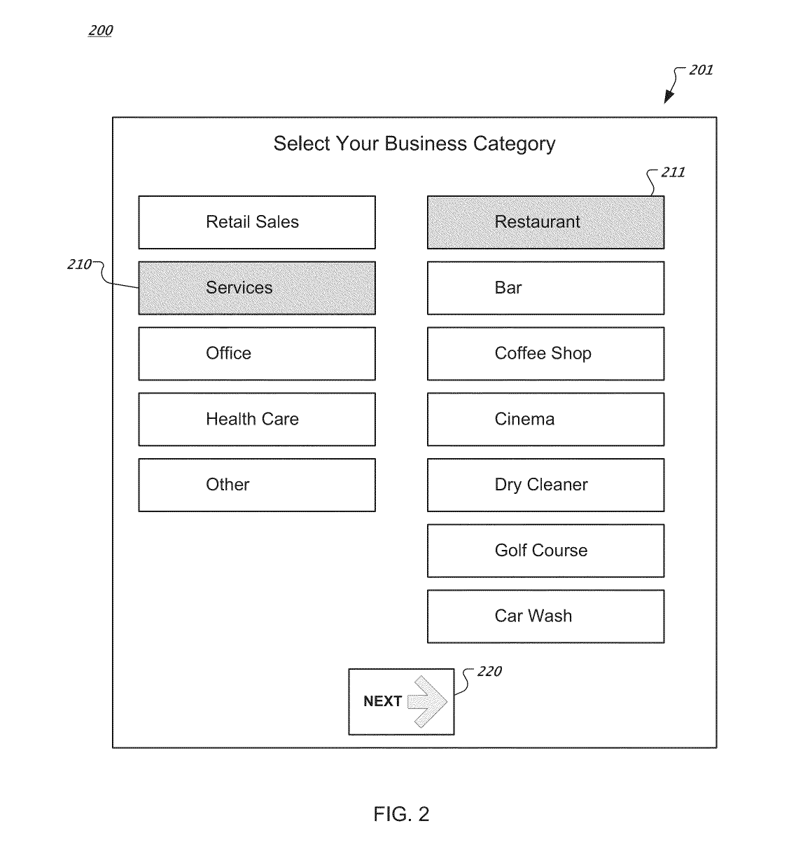

FIGS. 2-4 illustrate examples of user interfaces for selecting business tools for configuring network security policy of the firewall 114. The user interfaces illustrated in FIGS. 2-4 can be user interfaces of an application (e.g., a web browser) running on one or more processors of a connected device 102 in the computer network 120.

To select a business tool, the user can first select a business category, for example. User interface 201 in FIG. 2 illustrates an example user interface for selecting a business category. The user can select from a main category (e.g., retail sales, service, office, health care, as so on), a sub-category (e.g., restaurant, bar, coffee shop, cinema, dry cleaner, golf course, car wash, and so on) that best describes the user's business. In this example, the user selects “Services” (210) from the main category, and selects “Restaurant” (211) for his/her business. After selecting a business category, the user can navigate (e.g., by selecting the “NEXT” icon 220) to another user interface for selecting business tools of the selected business category.

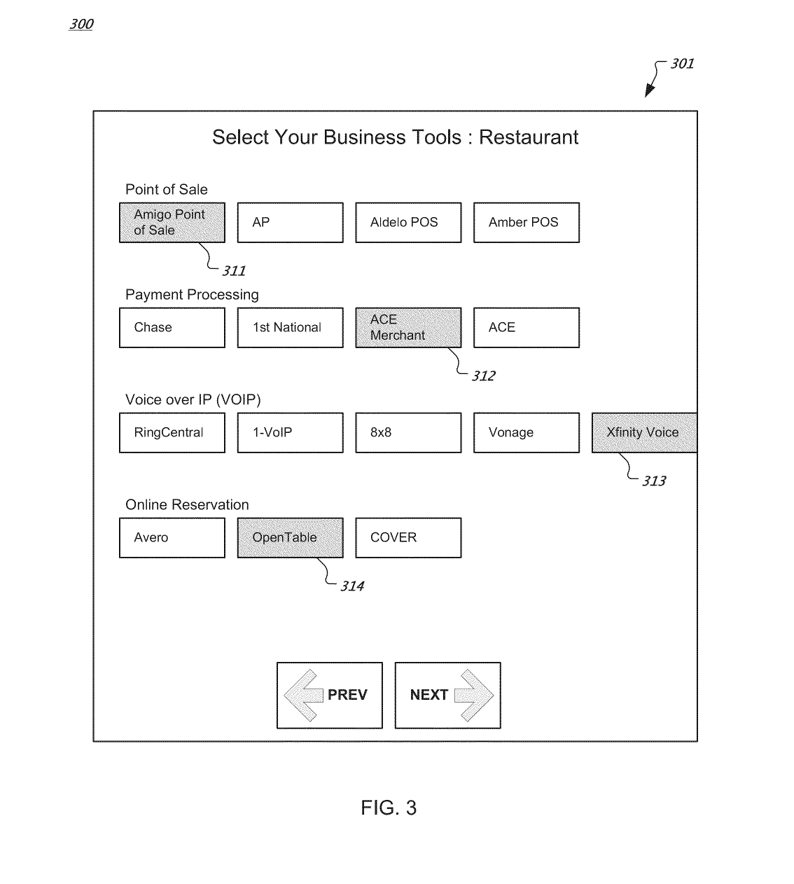

FIG. 3 illustrates an example user interface 301 for selecting business tools of a selected business category. In this example, the user can select business tools for a business category in restaurant. The user interface 301 provides types of business tools that are commonly used for a restaurant in several areas: point of sale system, payment processing system, VOIP phone system, and online reservation system. In this example, the user selects “Amigo Point of Sale” (311) for the point of sale system, “ACE” (312) as the provider for the payment processing system, “Xfinity Voice” (313) as the provider for the VOIP system, and “OpenTable” (314) as the provider for the online reservation system. Note that the user does not have to select all business tools at the same time. For instance, the user can first select a point of sale system, a payment processing system, and an online reservation system by using the example user interface 301. When the user purchased a VOIP system at a later time, the user can add the VOIP system to the list of business tools in use—e.g., by using the example user interface 301.

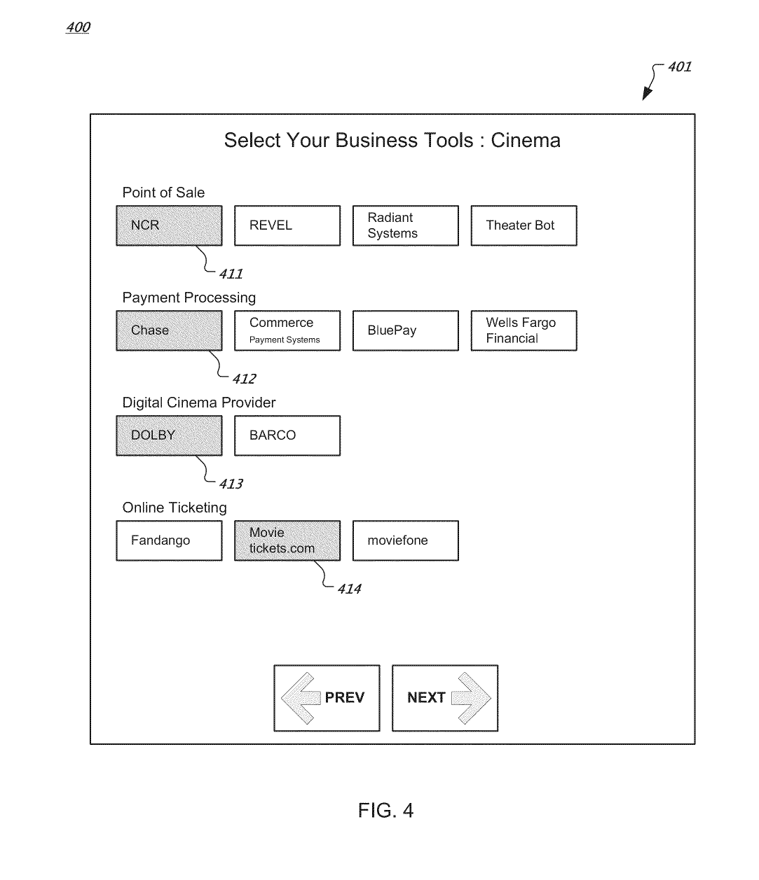

FIG. 4 illustrates another example user interface 401 for selecting business tools of a selected business category. In this example, the user can select business tools for a business category in cinema. The user interface 401 provides types of business tools that are commonly used for a cinema in several areas: point of sale system, payment processing system, digital cinema provider, and online ticketing system. In this example, the user selects “NCR” (411) for the point of sale system, “Chase” (412) as the provider for the payment processing system, “DOLBY” (413) as the digital cinema provider, and “Movietickets.com” (414) as the provider for the online ticketing system.

Here, a business category can have the same or different commonly used types of business tools as compared to another business category. A business category can have one or more industry-specific types of business tools that are not applicable to another business category. For instance, a restaurant can have an online reservation system for reserve seating in the restaurant. A cinema can have an online ticketing system for customers to purchasing movie tickets online. A cinema can have a digital cinema provider (that transmits movie content digitally to the cinema), which is not applicable to most of (if not all) restaurants. As another example, a realtor's office does not need point of sale and payment processing systems that are used in restaurants and cinemas, but may have a VOIP system that is used in restaurants and many other businesses.

Even for the same type of business tools, different business categories can have different often used tools. For instance, often used point of sale systems for a restaurant can be Amigo Point of Sale, AP, Aldelo POS, and Amber, as illustrated in FIG. 3. These point of sale systems are more tailored to a restaurant's needs. Often used point of sale systems for a cinema can be NCR, REVEL, Radiant Systems, and Theater Bot, as illustrated in FIG. 4. These point of sale systems are more tailored to a larger retail environment and a cinema's needs.

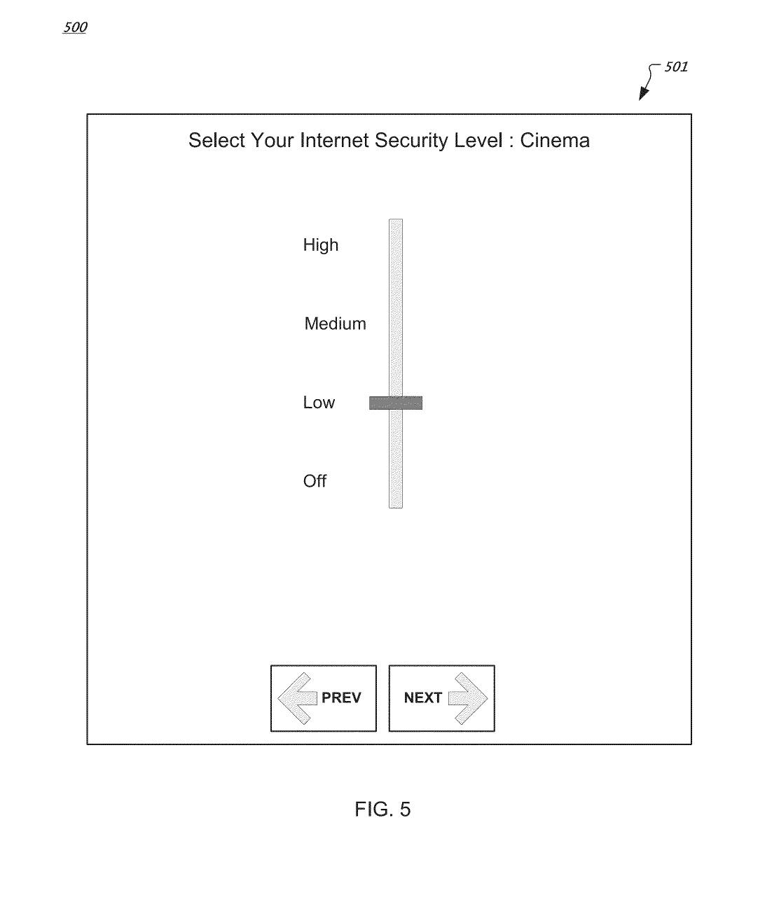

In addition to selecting business tools, the user can select a restriction level for network traffic monitored by the firewall 114. The restriction level can set security policies, for example, for web filtering in what web traffic can be allowed or blocked for the computer network 120. FIG. 5 illustrates an example user interface 501 for selecting a restriction level for network traffic. In the example user interface 501, the user can select a restriction level setting in high, medium, low or off. For instance, the user can navigate to the user interface 501 from the business tools selection user interface (e.g., 301 or 401) after selecting business tools for configuring the firewall 114.

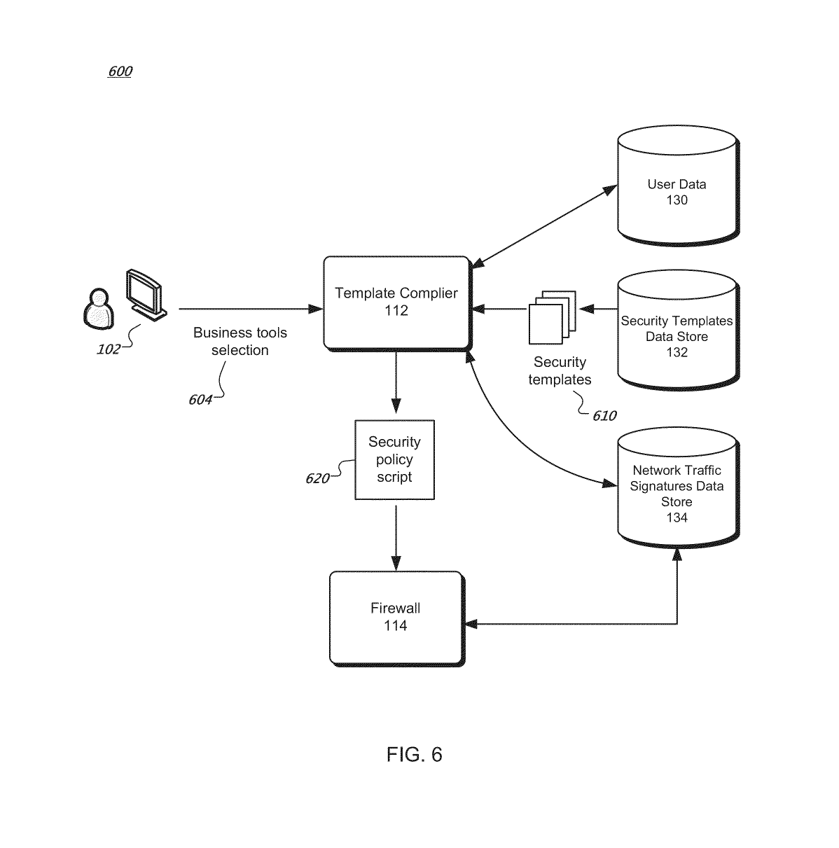

FIG. 6 is a data flow diagram of an example method for automatic network firewall policy determination, based on the system illustrated in FIG. 1, for example. The method can be implemented using software components executing on one or more data processing apparatus that are part of the data center 121 described earlier. A user can select business tools at one or more user interfaces displayed by a connected device 102 of the computer network 122, causing the connected device 102 to send the business tools selection 604 (e.g., identifiers for the selected business tools) to the template compiler 112. The user interfaces (e.g., user interfaces 201, 301, and 401 illustrated in FIGS. 2-4) can be web pages or structured documents served by the template compiler 112. The template compiler 112 can store the user's selection in business tools in the user data database 130. The user data base 130 can store other user data such as access credentials, contact information, and billing information.

In some implementations, the template compiler 112 and the firewall 114 (or another software component of the server system 122) can identify a business tool by inspecting network traffic of a previous unknown software and compare with network traffic signatures stored in the network traffic signature data store database 134. The template complier 112 and the firewall 114 can identify a particular business tool if the network traffic of the previous unknown software has network traffic characteristics that match the particular business tool's network traffic signature (e.g., matching address, port number, and network protocol).

Based on the business tools selected by the user, the template compiler 112 accesses the security templates data store database 132 and retrieve a security template 610 for each of the business tools.

A security template can comprise one or more security policies such as security rules and access lists. A security policy can include one or more security policy parameters such as, for example, an incoming interface, outgoing interface, source address, destination address, schedule, and service.

The incoming interface is the interface or interfaces that network traffic is first connected to the firewall 114. The outgoing interface is the interface or interfaces that network traffic first leaves the firewall 114. The incoming and outgoing interfaces can be physical interface (e.g., an Ethernet port) or logical interface (e.g., a VPN tunnel).

The source address is where network traffic comes from. A security policy can also include source parameters in source user and source device type. The destination address is where network traffic heads to. A security policy can tightly or loosely control network traffic by specifying the source addresses and the destination addresses. For instance, a security policy can allow general web surfing by allowing for “all” source addresses for web traffic. As another example, a security policy can tightly control credit card transaction traffic by allowing credit card transaction traffic only to assigned addresses for a payment processor.

The schedule is the time frame that is applied to a security policy. For instance, a security policy can set the schedule as from midnight to two o'clock in the morning for allowing web upload traffic for a point of sale system (e.g., for uploading sales data to a central server after business hours).

The service can be TCP/IP port numbers that can be used to identify a protocols or a group of protocols allowed or blocked for a security policy.

The firewall 114 can inspect payload (or a portion of the payload) of a data packet and compare against a security policy, for example. The security policy can be invoked when all its parameters are matched to the payload of the data packet. If the security policy is invoked, the firewall 114 can allow or block (e.g., silently drop) the packet, depending on the allow/block condition set in the security policy. Meanwhile, all other security policies can be ignored for the data packet. In some implementations, multiple security policies are arranged in an ordered sequence. A data packet are compared to parameters of the security polices starting from the policy at the top of the sequence. In this way, a more specific or specialized policy can be placed near the top of the sequence in order to be effective.

In some implementations, a security policy can be based on one or more network traffic signatures (often referred as Intrusion Prevention System or IPS signatures) that are used to monitor network traffic, and allow or block network traffic of one or more particular software applications by comparing payload of data packets of the network traffic to the signatures. The IPS signatures can be stored in the network traffic signature data store database 134.

By way of illustration, a security template of a point of sale system “A” can include, among other things:
A1: block all credit card upload with DLP (Data Loss Prevention)
A2: block all web browsing network traffic
A3: allow update web protocol to an assigned web address
A4: allow DNS (Domain Name System) resolution and NTP (Network Time Protocol) synchronization to assigned servers
A5: block all other traffic

A security template for another point of sale system “B” can include, among other things:
B1: block all credit card upload with DLP
B2: block all web browsing network traffic
B3: allow update web protocol to an assigned web address
B4: allow DNS resolution and NTP synchronization to assigned servers
B5: allow a remote support tool (e.g., Team Viewer) connection to assigned IP addresses
B6: block all other traffic

A security template for a credit card processing service “C” can include, among other things:
C1: block all network traffic and allow only credit card authorization transactions to assigned servers.

A security template for a VOIP application “D” can include, among other things:
D1: allow SIP (Session Initiation Protocol) data traffic to SBC (Session Border Controller) IP addresses
D2: prioritize SIP data traffic over other data traffic

A security template for another VOIP application “E” based on peer-to-peer connections can include, among other things:
E1: allow the application's connection to all IP addresses (for peer-to-peer connections)
E2: prioritize the application's voice and video traffic over other data traffic

A security template for an online reservation service “F” can include, among other things:
F1: allow POS (point of sale) communication to assigned servers with web protocol for reservation

As illustrated above, security policies in a security template for a business tool are often constructed (e.g., by the business tools' service provider) specifically for the corresponding business tool. These policies can have overlaps and conflicts with security policies for another business tool. For instance, if the point of sale system “A” and the credit card processing service “C” are both used in the computer network 120, the policy A1 above can block data traffic allowed by the policy C1, thus disabling the ability to authorize credit card transactions properly. As another example, if the point of sale system “A,” the credit card processing service “C,” and the VOIP application “D” are used in the computer network 120, the policy C1 can block data traffic (and related functionalities) allowed by the policies A3, A4, D1, and D2, and effectively disable the VOIP application “D.”

The template complier 112 can identify and resolve conflicting security policies between security templates for multiple business tools, and compile a security policy script that enables functionalities of the business tools. The template compiler 112 can identify conflicting security policies between templates for multiple business tools by comparing allowed or blocked traffic specified by the security policies for the business tools, for example. The template complier 112 can resolve conflicting security policies by adding, removing, or updating one or more of the identified conflicting security policies. The template compiler 112 can update a security policy by modifying the security policy's parameters such as source or destination address or port numbers described earlier. In some implementations, the template complier 112 can update a security policy by adding to or deleting one or more IPS signatures from the security policy.

For instance, if the selected business tools in the computer network 120 are the point of sale system “A” and the credit card processing service “C,” the template compiler 112 can identify that the rules A1 and A5 can block traffic for the credit card processing service “C,” while the rule C1 can block traffic for the point of sale system “A.” The template compiler 112 can compile a security policy script by removing the rules A1 and A5, and updating the rule C1 to allow credit card authorization transactions to assigned servers (in addition to allowing other network traffic). The resulting security policy includes the rules A2, A3, A4 and the updated rule C1, that allow credit card authorization transactions to go through for the credit card processing service “C,” and allow web update, DNS resolution, and NTP synchronization for the point of sale system “A.”

After compiling the security policy script by identifying and resolving conflicting security policies, the template compiler 112 provides the security policy script (620) to the firewall 114. The firewall 114 can monitor network traffic of the selected business tools based on the security policy script.

In some implementations, the template complier 112 can store a security policy script of a particular combination of business tools, in the security templates data store database 132. In this way, the security policy script can be reused for another computer network that deploys the same particular combination of business tools and uses the firewall 114 to monitor network traffic.

The template compiler 112 can heuristically update the security policy script based on network traffic characteristics and signatures observed by the firewall 114 (or another software component of the server system 122). For instance, when the selected business tools are the point of sale system “A” and the credit card processing service “C” described earlier, the template compiler 112 can compile a first version of a security policy script including the rules A2, A3, and A4, and allowing all credit card upload traffic with DLP. In this way, overlap and conflicts between security policies for the point of sale system “A” and the credit card processing service “C” are absent in the first version of the security policy script. The firewall 114 can monitor network traffic to and from the computer network 120 based on the first version of the security policy script. The firewall 114 may observe most credit card authorization traffic going to specific addresses during business hours (e.g., between 10 AM and 10 PM). The template compiler 112 then can “tighten” network security for the computer network 120 by compiling a second version of the security policy script including an updated rule allowing credit card authorization transactions to the specific addresses and within a time frame between 10 AM and 10 PM, and provide the second version to the firewall 114. The firewall 114 continues to monitor network traffic to and from the computer network 120 based on the second version (a “stricter” version) of the security policy script.

The template compiler 112 can update a security template based on a security policy that has been identified as conflicting with one or more security policies of another security template. For instance, the template compiler 112 may observe that the rules A1 and A5 can conflict with another business tool that is often selected with the point of sale system “A” (e.g., resulting dropping network traffic of a credit card payment tool or a VOIP application). The template compiler 112 can update the security template for the point of sale system “A” by including the rules A2, A3, and A4, and allowing VOIP and credit card transaction network traffic. In this way, the updated security template for the point of sale system “A” is more “lenient” and less likely to overlap and conflict with security policies of other business tools. The template compiler 112 can heuristically update (“tighten”) the resulting security policy script as described earlier. For instance, the template compiler 112 (and the firewall 114) may observe frequent VOIP traffic to certain particular addresses. The template compiler 112 can update the security policy script by limiting VOIP traffic to the particular addresses.

The template compiler 112 can include in a security policy script one or more security policies based on a restriction level for network traffic selected by the user, for example, using the user interface 501 of FIG. 5. The restriction level can set web filtering security policies that block or allow certain types of web traffic for the computer network 120. For instance, a web filtering security policy can include a block or allow list of one or more destination locations for HTTP requests from a connected device 102 in the computer network 120. A web filtering security policy can also be a block list of specific data (e.g., text strings related to inappropriate content) that may be on websites from which a connected device 102 requests web content. By way of illustration, if the selected restriction level is low, the security policy script can include security policies that block inappropriate content (e.g., violence, pornography) but allow all other web traffic. If the selected restriction level is medium or high, the security policy script can include security policies that block most of network traffic except for selected business category and business tools, for example, based on IP addresses of the selected business tools. For example, if the selected restriction level is high for a realtor, the security policy script can allow network traffic only for the selected business tools (e.g., a VOIP system) and software or web content for the selected business category (e.g., Zillow).

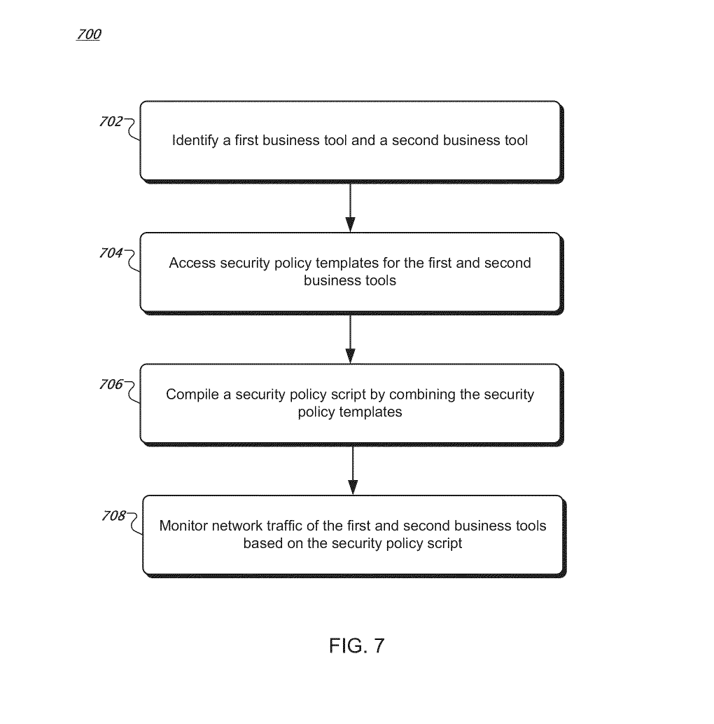

FIG. 7 is a flow chart of another example method for automatic network firewall policy determination. The method can be implemented using software components executing on one or more data processing apparatus that are part of the data center 121 described earlier. The method begins by identifying a first business tool and a second business tool (702). The method accesses security policy templates for the first and second business tools (704). The method compiles a security policy script by combining the security policy templates (706). The method combines the security policy templates by identifying and resolving conflicting security policies of the security policy templates. The method monitors network traffic of the first and second business tools based on the security policy script (708). The method monitors the network traffic by applying the security policy script to a network security system, causing the network security system to monitor network traffic of the first and second business tools based on the security policy script.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
identifying a first business tool and a second business tool;
accessing security policy templates for the first and second business tools;
compiling a security policy script by combining the security policy templates wherein compiling the security templates comprises identifying and resolving conflicting security policies; and
monitoring network traffic of the first and second business tools based on the security policy script,
wherein identifying, accessing, compiling, and monitoring are performed by one or more computer processors.

2. The method of claim 1, wherein monitoring network traffic comprises applying the security policy script to a network security system, causing the network security system to monitor network traffic of the first and second business tools based on the security policy script.

3. The method of claim 1, wherein identifying a particular business tool comprises:
inspecting network traffic of a previously unknown software; and
determining whether the network traffic of the previously unknown software has characteristics matching a network traffic signature of the particular business tool.

4. The method of claim 1, wherein resolving conflicting security policies comprises adding, removing, or updating one or more of the identified conflicting security policies.

5. The method of claim 1, further comprising heuristically updating the security policy script including:
inspecting network traffic of the first and second business tools for respective network traffic characteristics; and
updating the security policy script by adding, removing, or updating one or more particular security policies from the security policy script based on the respective network traffic characteristics.

6. The method of claim 1, further comprising updating at least one of the security policy templates based on at least one of the identified conflicting security policies.

8. The method of claim 1, wherein a particular business tool is a payment processing system, point of sale system, phone system, or online reservation system.

9. The method of claim 1, wherein identifying a particular business tool comprises receiving an identifier of the particular business tool from a graphical user interface of a remote computer system.

10. A system comprising one or more computer processors programed to perform operations comprising:
receiving user selection of a business category in a first interface of a first computer system; and
receiving user selection of one or more business tools in a second interface of the first computer system and, based thereon:
accessing a data store for security policy templates for the selected business tools;
compiling a security policy script by combining the security policy templates wherein compiling the security templates comprises identifying and resolving conflicting security policies; and
applying the security policy script to a network security system, causing the network security system to monitor network traffic of the selected business tools to or from the first computer system based on the security policy script.

11. The system of claim 10, wherein a particular selected business tool is a payment processing system, point of sale system, phone system, or online reservation system for the selected business category.

12. The system of claim 10, wherein the one or more computer processors are programed to perform further operations comprising:
receiving user selection of a restriction level for network traffic in a third interface of the first computer and, based thereon, compiling the security policy script further based on the restriction level.

13. The system of claim 10, wherein the network traffic of the selected business tools to or from the first computer system is based, at least, on a network tunneling protocol.
